(19) United States
(12) Patent Application Publication
(10) Pub. No.: US 2020/0361074 A1
(43) Pub. Date: Nov. 19, 2020

(54) Clamp On Straight Edge Device

(71) Applicant: Kellen Davis, Greensboro, NC (US)

(72) Inventor: Kellen Davis, Greensboro, NC (US)

(21) Appl. No.: 16/414,839

(22) Filed: May 17, 2019

(51) Int. Cl. B25H 1/00; F16B 2/06; B25H 7/00

(52) U.S. Cl. CPC B25H 1/0078; B25H 7/00; F16B 2/065

(57) ABSTRACT

A clamp on straight edge device for guiding for a tool includes a slot that is positioned longitudinally through a bar. A pair of coupling assemblies is slidably positioned in the slot. The coupling assemblies are selectively couplable to the bar so that each coupling assembly is fixedly positionable within the slot. Each coupling assembly is configured to position in abutment to a respective edge of a workpiece. The coupling assembles then are coupled to the bar to couple the bar to the workpiece with the bar extending linearly between the pair of coupling assemblies across a respective face of the workpiece. A user is positioned to selectively mark, score, perforate, cut, or otherwise alter the workpiece along a respective opposing side of the bar using a tool, such as a hand held powered cutting tool or the like.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to straight edge devices and more particularly pertains to a new straight edge device for guiding for a tool.

### (2) Description of Related Art Including Information Disclosed Under 37 CFR 1.97 and 1.98

The prior art relates to straight edge devices.

### BRIEF SUMMARY OF THE INVENTION

An embodiment of the disclosure meets the needs presented above by generally comprising a slot that is positioned longitudinally through a bar. A pair of coupling assemblies is slidably positioned in the slot. The coupling assemblies are selectively couplable to the bar so that each coupling assembly is fixedly positionable within the slot. Each coupling assembly is configured to position in abutment to a respective edge of a workpiece. The coupling assembles then are coupled to the bar to couple the bar to the workpiece with the bar extending linearly between the pair of coupling assemblies across a respective face of the workpiece. A user is positioned to selectively mark, score, perforate, cut, or otherwise alter the workpiece along a respective opposing side of the bar using a tool, such as a hand held powered cutting tool or the like.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a clamp on straight edge device according to an embodiment of the disclosure.

FIG. 2 is a top view of an embodiment of the disclosure.

FIG. 3 is a side view of an embodiment of the disclosure.

FIG. 4 is a bottom view of an embodiment of the disclosure.

FIG. 5 is an end view of an embodiment of the disclosure.

FIG. 6 is an exploded view of an embodiment of the disclosure.

FIG. 7 is an in-use view of an embodiment of the disclosure.

FIG. 8 is an in-use view of an embodiment of the disclosure.

FIG. 9 is an isometric perspective view of an alternative embodiment of the disclosure.

FIG. 10 is an isometric perspective view of an alternative embodiment of the disclosure.

### DETAILED DESCRIPTION OF THE INVENTION

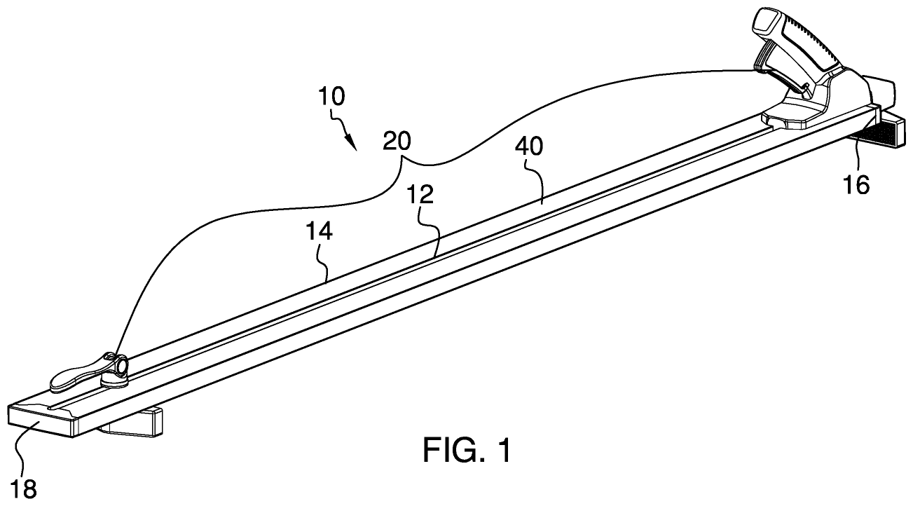

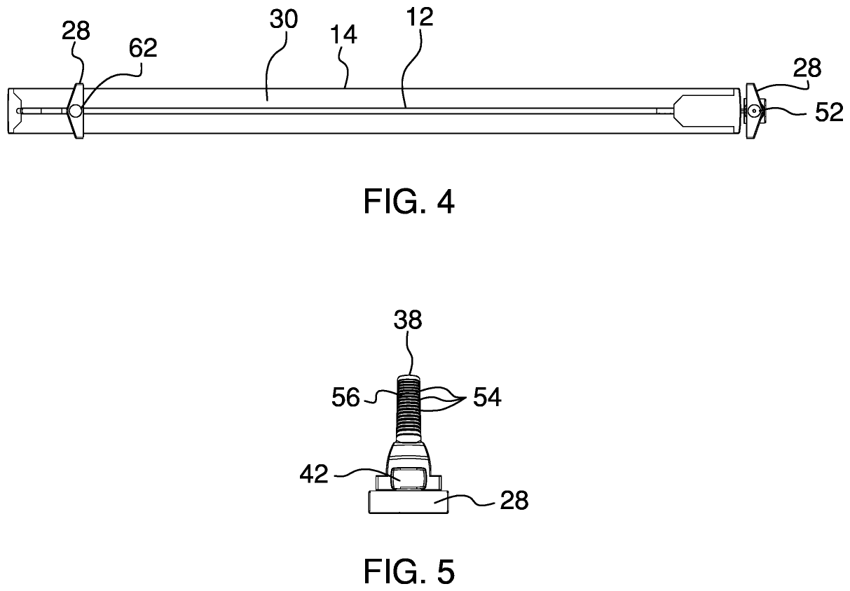

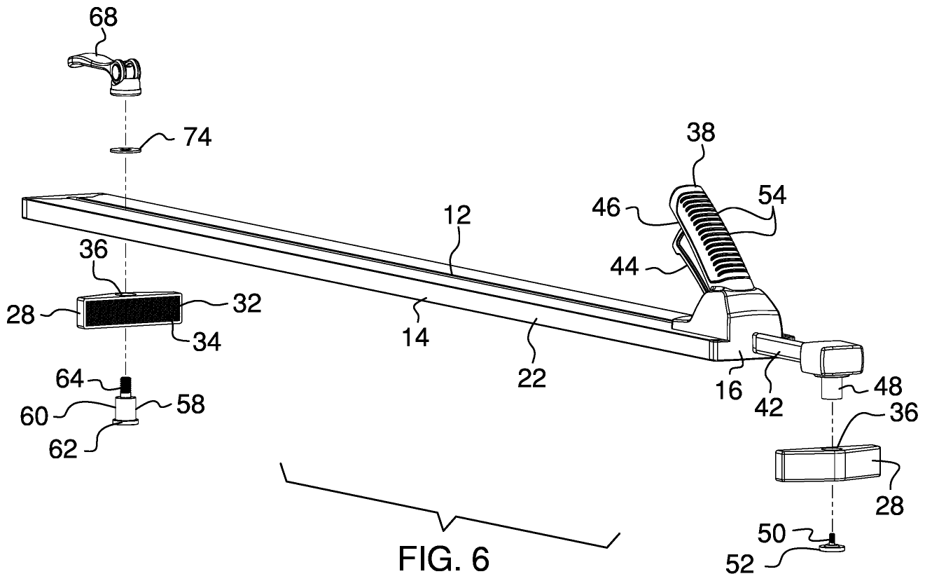

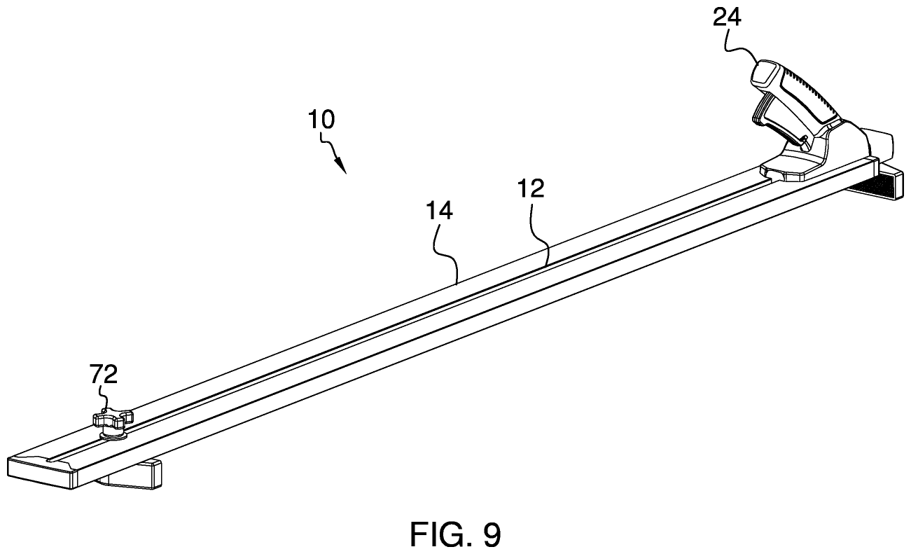

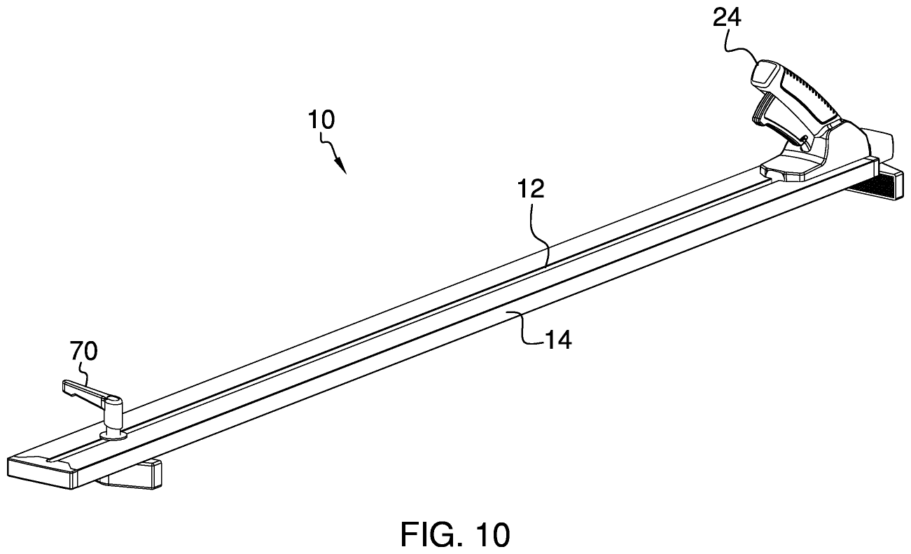

With reference now to the drawings, and in particular to FIGS. 1 through 10 thereof, a new straight edge device embodying the principles and concepts of an embodiment of the disclosure and generally designated by the reference numeral 10 will be described.

As best illustrated in FIGS. 1 through 10, the clamp on straight edge device 10 generally comprises a slot 12 that is positioned longitudinally through a bar 14. The slot 12 extends from proximate to a first end 16 to proximate to a second end 18 of the bar 14.

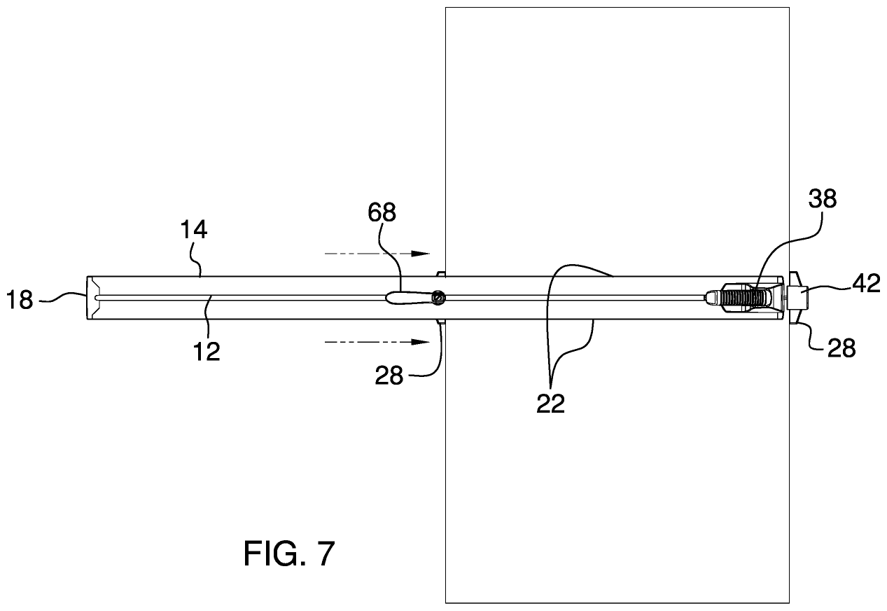

A pair of coupling assemblies 20 is slidably positioned in the slot 12. The coupling assemblies 20 are selectively couplable to the bar 14 so that each coupling assembly 20 is fixedly positionable within the slot 12. Each coupling assembly 20 is configured to position in abutment to a respective edge of a workpiece. The coupling assembles then are coupled to the bar 14 to couple the bar 14 to the workpiece with the bar 14 extending linearly between the pair of coupling assemblies 20 across a respective face of the workpiece, as shown in FIG. 7. A user is positioned to selectively mark, score, perforate, cut, or otherwise alter the workpiece along a respective opposing side 22 of the bar 14 using a tool, such as a hand held powered cutting tool or the like.

On advantage of the device 10 over prior art straight edge devices is that the prior art devices require the user to flip the device over for adjusting the coupling assemblies 20. The prior art devices also are unforgiving in requiring the user to be quite precise in setting a distance between the coupling assemblies 20 to successfully clamp the prior art device to a workpiece.

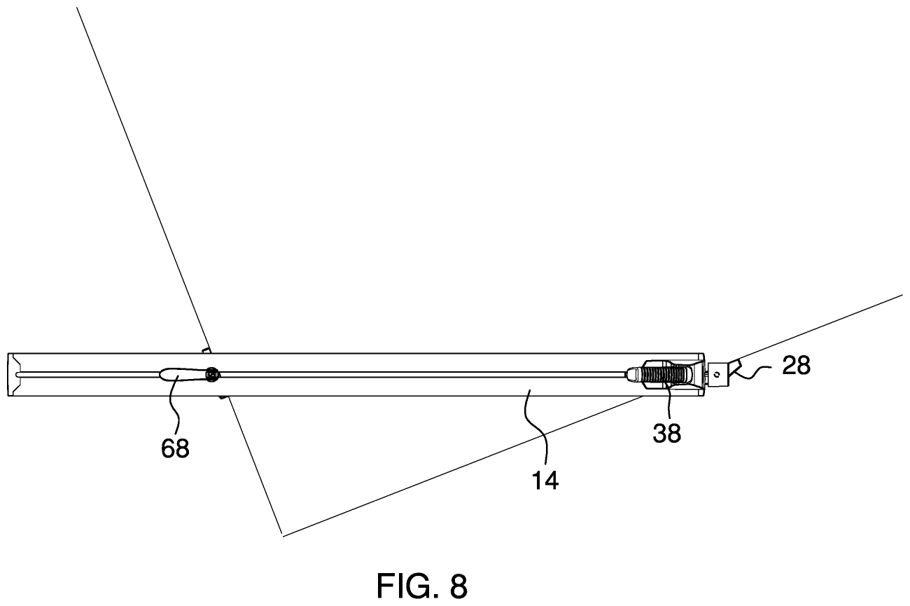

Each coupling assembly 20 is selectively rotatable relative to the bar 14 so that the pair of coupling assemblies 20 is configured to position in abutment to adjacent edges of a workpiece that has a simple polygonal geometric shape and to position in abutment to a pair of sections of workpiece that has a curved shape. The coupling assemblies 20 being rotatable provides another significant advantage over prior art straight edge devices in that the claimed device allows for guided cutting at extreme angles, as shown in FIG. 8.

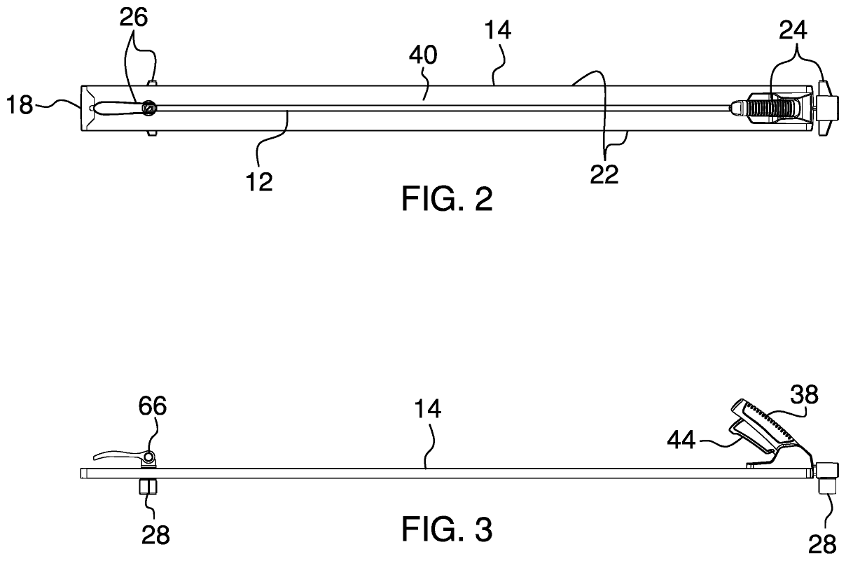

The pair of coupling assemblies 20 comprises a first assembly 24 that is fixedly coupled to the first end 16 of the bar 14 and a second assembly 26 that is selectively slidably positionable in the slot 12 from proximate to the second end 18 of the bar 14 to proximate to the first assembly 24, as shown in FIG. 2. The first assembly 24 and the second assembly 26 each comprise a block 28 that is positioned below a lower face 30 of the bar 14. A pad 32 that is coupled to a first facet 34 of the block 28 is configured to frictionally couple to the respective edge of the workpiece. The pad 32 comprises at least one of rubber and silicone. A hole 36 positioned in the block 28.

The first assembly 24 comprises a handle grip 38 that is coupled to and extends transversely from an upper face 40 of the bar 14 toward the second end 18 of the bar 14. A rod 42 is selectively extensible from the handle grip 38 past the first end 16 of the bar 14. The block 28 is coupled to the rod 42 distal from the handle grip 38.

A lever 44 that is pivotally coupled to the handle grip 38 is operationally coupled to rod 42. The lever 44 is spring-loaded so that the lever 44 is biased to an extended positioned. The lever 44 and the handle grip 38 are configured to be squeezed in a hand of the user to pivot the lever 44 to selectively retract the rod 42 into the handle grip 38 so that the block 28 is frictionally coupled to the respective edge of the workpiece. The lever 44 is positioned on an inner face 46 of the handle grip 38.

A tube 48, which is internally threaded, is coupled to and extends perpendicularly from the rod 42 distal from the handle grip 38. The tube 48 is complementary to the hole 36 in the block 28 so that the hole 36 is positioned to insert the tube 48. A screw 50 is selectively insertable into the hole 36 and threadedly insertable into the tube 48 to removably couple the block 28 to the rod 42. The screw 50 has a head 52 that is circumferentially larger than the hole 36 so that the head 52 frictionally couples to the block 28. A plurality of recesses 54 that is positioned in an outer face 56 of handle grip 38 is configured for enhancing a grasp of the hand upon the handle grip 38.

The second assembly 26 comprises a connector 58 that is coupled to the block 28 and extends through the slot 12. The connector 58 comprises a cylinder 60 that is coupled to and positioned between a flare 62 and a bolt 64. The flare 62 is circumferentially larger than the hole 36 so that the flare 62 frictionally couples to the block 28 as the bolt 64 and the cylinder 60 are inserted through the hole 36.

A locking element 66 is coupled to the connector 58 and is positioned adjacent to the upper face 40 of the bar 14. The locking element 66 is configured to be grasped in the hand of the user to selectively position the second assembly 26 within the slot 12 so that the locking element 66 is positioned is actuated by action of the hand of the user to selectively motivate the block 28 toward the lower face 30 of the bar 14 so that the block 28 and the locking element 66 frictionally couple to the bar 14 to fixedly position the second assembly 26 within the slot 12. The locking element 66 is threadedly couplable to the connector 58. The locking element 66 comprises at least one of a lever type clamping handle 68, a rotatable rod type handle 70, a rotatable knob 72, or the like. A washer 74 that is selectively positionable between the locking element 66 and the bar 14 is positioned to facilitate sliding of the second assembly 26 within the slot 12.

In use, the bar 14 is positioned on the respective face of the workpiece and the second assembly 26 is slid in the slot 12 to bring the block 28 of the second assembly 26 into abutment with a respective edge of the workpiece. The lever 44 then is depressed for a number of times required to retract the rod 42 into the handle grip 38 such that the block 28 of the first assembly 24 it brought into abutment with a second edge of the workpiece to fixedly position the bar 14. The user is positioned to selectively mark, score, perforate, cut, or otherwise alter the workpiece along a respective opposing side 22 of the bar 14 using a tool.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A clamp on straight edge device comprising:
a bar;
a slot positioned longitudinally through the bar; and
a pair of coupling assemblies slidably positioned in the slot, the coupling assemblies being selectively couplable to the bar such that each coupling assembly is fixedly positionable within the slot wherein each coupling assembly is configured for positioning in abutment to a respective edge of a workpiece positioning the coupling assembles for coupling to the bar for coupling the bar to the workpiece with the bar extending linearly between the pair of coupling assemblies across a respective face of the workpiece such that a user is positioned for selectively marking, scoring, perforating, and cutting the workpiece along a respective opposing side of the bar.

2. The device of claim 1, further including the slot extending from proximate to a first end to proximate to a second end of the bar.

3. The device of claim 1, further including each coupling assembly being selectively rotatable relative to the bar such that the pair of coupling assemblies is configured for positioning in abutment to adjacent edges of a workpiece having a simple polygonal geometric shape and for positioning in abutment to a pair of sections of a workpiece having a curved shape.

4. The device of claim 1, further including the pair of coupling assemblies comprising a first assembly fixedly coupled to a first end of the bar and a second assembly selectively slidably positionable in the slot from proximate to a second end of the bar to proximate to the first assembly.

5. The device of claim 4, further including the first assembly and the second assembly each comprising:
a block positioned below a lower face of the bar; and
a hole positioned in the block.

6. The device of claim 5, further including a pad coupled to a first facet of the block wherein the pad is configured for frictionally coupling to the respective edge of the workpiece.

7. The device of claim 6, further including the pad comprising at least one of rubber and silicone.

8. The device of claim 5, further comprising:
the first assembly comprising:
a handle grip coupled to and extending transversely from an upper face of the bar toward the second end of the bar,
a rod selectively extensible from the handle grip past the first end of the bar, the block being coupled to the rod distal from the handle grip, and
a lever pivotally coupled to the handle grip, the lever being operationally coupled to rod, the lever being spring-loaded such that the lever is biased to an extended positioned wherein the lever and the handle grip are configured for squeezing in a hand of the user for pivoting the lever for selectively retracting the rod into the handle grip such that the block is frictionally coupled to the respective edge of the workpiece; and
the second assembly comprising:
a connector coupled to the block and extending through the slot, and
a locking element coupled to the connector and positioned adjacent to the upper face of the bar wherein the locking element is configured for grasping in the hand of the user for selectively positioning the second assembly within the slot such that the locking element is positioned being actuated by action of the hand of the user for selectively motivating the block toward the lower face of the bar such that the block and the locking element frictionally couple to the bar for fixedly positioning the second assembly within the slot.

9. The device of claim 8, further including the lever being positioned on an inner face of the handle grip.

10. The device of claim 8, further comprising:
a tube coupled to and extending perpendicularly from the rod distal from the handle grip, the tube being internally threaded, the tube being complementary to the hole in the block such that the hole is positioned for inserting the tube; and
a screw selectively insertable into the hole and threadedly insertable into the tube for removably coupling the block to the rod.

11. The device of claim 10, further including the screw having a head, the head being circumferentially larger than the hole such that the head frictionally couples to the block.

12. The device of claim 9, further including a plurality of recesses positioned in an outer face of handle grip wherein the recesses are configured for enhancing a grasp of the hand upon the handle grip.

13. The device of claim 8, further comprising:
the locking element being threadedly couplable to the connector; and
the connector comprising a cylinder coupled to and positioned between a flare and a bolt, the flare being circumferentially larger than the hole such that the flare frictionally couples to the block as the bolt and the cylinder are inserted through the hole.

14. The device of claim 13, further including a washer selectively positionable between the locking element and the bar such that the washer is positioned for facilitating sliding of the second assembly within the slot.

15. The device of claim 8, further including the locking element comprising at least one of a lever type clamping handle, a rotatable rod type handle, and a rotatable knob.

16. A clamp on straight edge device comprising:
a bar;
a slot positioned longitudinally through the bar, the slot extending from proximate to a first end to proximate to a second end of the bar;
a pair of coupling assemblies slidably positioned in the slot, the coupling assemblies being selectively couplable to the bar such that each coupling assembly is fixedly positionable within the slot wherein each coupling assembly is configured for positioning in abutment to a respective edge of a workpiece positioning the coupling assembles for coupling to the bar for coupling the bar to the workpiece with the bar extending linearly between the pair of coupling assemblies across a respective face of the workpiece such that a user is positioned for selectively marking, scoring, perforating, and cutting the workpiece along a respective opposing side of the bar, each coupling assembly being selectively rotatable relative to the bar such that the pair of coupling assemblies is configured for positioning in abutment to adjacent edges of a workpiece having a simple polygonal geometric shape and for positioning in abutment to a pair of sections of workpiece having a curved shape, the pair of coupling assemblies comprising a first assembly fixedly coupled to a first end of the bar and a second assembly selectively slidably positionable in the slot from proximate to a second end of the bar to proximate to the first assembly, the first assembly and the second assembly each comprising:
a block positioned below a lower face of the bar,
a pad coupled to a first facet of the block wherein the pad is configured for frictionally coupling to the respective edge of the workpiece, the pad comprising at least one of rubber and silicone, and
a hole positioned in the block;
the first assembly comprising:
a handle grip coupled to and extending transversely from an upper face of the bar toward the second end of the bar,
a rod selectively extensible from the handle grip past the first end of the bar, the block being coupled to the rod distal from the handle grip,
a lever pivotally coupled to the handle grip, the lever being operationally coupled to rod, the lever being spring-loaded such that the lever is biased to an extended positioned wherein the lever and the handle grip are configured for squeezing in a hand of the user for pivoting the lever for selectively retracting the rod into the handle grip such that the block is frictionally coupled to the respective edge of the workpiece, the lever being positioned on an inner face of the handle grip,
a tube coupled to and extending perpendicularly from the rod distal from the handle grip, the tube being internally threaded, the tube being complementary to the hole in the block such that the hole is positioned for inserting the tube,
a screw selectively insertable into the hole and threadedly insertable into the tube for removably coupling the block to the rod, the screw having a head, the head being circumferentially larger than the hole such that the head frictionally couples to the block, and
a plurality of recesses positioned in an outer face of handle grip wherein the recesses are configured for enhancing a grasp of the hand upon the handle grip; and
the second assembly comprising:
a connector coupled to the block and extending through the slot, the connector comprising a cylinder coupled to and positioned between a flare and a bolt, the flare being circumferentially larger than the hole such that the flare frictionally couples to the block as the bolt and the cylinder are inserted through the hole,
a locking element coupled to the connector and positioned adjacent to the upper face of the bar wherein the locking element is configured for grasping in the hand of the user for selectively positioning the second assembly within the slot such that the locking element is positioned being actuated by action of the hand of the user for selectively motivating the block toward the lower face of the bar such that the block and the locking element frictionally couple to the bar for fixedly positioning the second assembly within the slot, the locking element being threadedly couplable to the connector, the locking element comprising at least one of a lever type clamping handle, a rotatable rod type handle, and a rotatable knob, and
a washer selectively positionable between the locking element and the bar such that the washer is positioned for facilitating sliding of the second assembly within the slot.
